(19) United States
(12) Patent Application Publication
(10) Pub. No.: US 2025/0088948 A1
(43) Pub. Date: Mar. 13, 2025

(54) METHOD AND APPARATUS FOR SMART REPEATER

(71) Applicant: Nokia Technologies Oy, Espoo (FI)

(72) Inventors: Ali KARIMIDEHKORDI, Munich (DE); Axel MUELLER, Paris (FR); Christian ROM, Aalborg (DK); Simon SVENDSEN, Aalborg (DK); Poul OLESEN, Støvring (DK)

(21) Appl. No.: 18/725,871

(22) PCT Filed: Jan. 4, 2022
(86) PCT No.: PCT/FI2022/050005

§ 371 Date: Jul. 1, 2024

(51) Int. Cl. H04W 48/16; H04B 7/185

(52) U.S. Cl. CPC H04W 48/16; H04B 7/18513

(57) ABSTRACT

A method including receiving, by a repeater, access link information from an access point over a backhaul link, wherein the access link information includes received power of one or more reference signals, or an indication of a spatial filter for an access link; and obtaining, by the repeater, based at least partly on the access link information, at least one spatial filter pair for the backhaul link and the access link.

### FIELD

The following exemplary embodiments relate to wireless communication.

### BACKGROUND

In a radio network, transmission and reception of wireless signals may be performed via directional spatial filters (beams) to increase the signal quality, reduce interference over neighbouring nodes, and compensate for additional propagation path-loss due to using higher carrier frequencies. There is a challenge in how to obtain optimal spatial filters (beams) for a repeater, which may be used to amplify and forward signals between a terminal device and an access point of a wireless communication network.

### SUMMARY

The scope of protection sought for various exemplary embodiments is set out by the claims. The exemplary embodiments and features, if any, described in this specification that do not fall under the scope of the claims are to be interpreted as examples useful for understanding various exemplary embodiments.

An apparatus comprising at least one processor, and at least one transceiver, wherein the at least one transceiver is configured to: receive access link information from an access point over a backhaul link, wherein the access link information comprises received power of one or more reference signals, or an indication of a spatial filter for an access link; and the at least one processor is configured to: obtain, based at least partly on the access link information, at least one spatial filter pair for the backhaul link and the access link.

According to an aspect, there is provided an apparatus comprising at least one processor, and at least one memory including computer program code, wherein the at least one memory and the computer program code are configured, with the at least one processor, to cause the apparatus to: receive access link information from an access point over a backhaul link, wherein the access link information comprises received power of one or more reference signals, or an indication of a spatial filter for an access link; and obtain, based at least partly on the access link information, at least one spatial filter pair for the backhaul link and the access link.

According to another aspect, there is provided an apparatus comprising means for: receiving access link information from an access point over a backhaul link, wherein the access link information comprises received power of one or more reference signals, or an indication of a spatial filter for an access link; and obtaining, based at least partly on the access link information, at least one spatial filter pair for the backhaul link and the access link.

According to another aspect, there is provided a method comprising: receiving, by a repeater, access link information from an access point over a backhaul link, wherein the access link information comprises received power of one or more reference signals, or an indication of a spatial filter for an access link; and obtaining, by the repeater, based at least partly on the access link information, at least one spatial filter pair for the backhaul link and the access link.

According to another aspect, there is provided a computer program product comprising program instructions which, when run on a computing apparatus, cause the computing apparatus to perform at least the following: receiving access link information from an access point over a backhaul link, wherein the access link information comprises received power of one or more reference signals, or an indication of a spatial filter for an access link; and obtaining, based at least partly on the access link information, at least one spatial filter pair for the backhaul link and the access link.

According to another aspect, there is provided a computer program comprising instructions for causing an apparatus to perform at least the following: receiving access link information from an access point over a backhaul link, wherein the access link information comprises received power of one or more reference signals, or an indication of a spatial filter for an access link; and obtaining, based at least partly on the access link information, at least one spatial filter pair for the backhaul link and the access link.

According to another aspect, there is provided a computer readable medium comprising program instructions for causing an apparatus to perform at least the following: receiving access link information from an access point over a backhaul link, wherein the access link information comprises received power of one or more reference signals, or an indication of a spatial filter for an access link; and obtaining, based at least partly on the access link information, at least one spatial filter pair for the backhaul link and the access link.

According to another aspect, there is provided a non-transitory computer readable medium comprising program instructions for causing an apparatus to perform at least the following: receiving access link information from an access point over a backhaul link, wherein the access link information comprises received power of one or more reference signals, or an indication of a spatial filter for an access link; and obtaining, based at least partly on the access link information, at least one spatial filter pair for the backhaul link and the access link.

An apparatus comprising at least one processor, and at least one transceiver, wherein the at least one processor is configured to: obtain access link information of a repeater, wherein the access link information comprises received power of one or more reference signals, or an indication of a spatial filter for an access link; and wherein the at least one transceiver is configured to: transmit, to the repeater, the access link information over a backhaul link.

According to another aspect, there is provided an apparatus comprising at least one processor, and at least one memory including computer program code, wherein the at least one memory and the computer program code are configured, with the at least one processor, to cause the apparatus to: obtain access link information of a repeater, wherein the access link information comprises received power of one or more reference signals, or an indication of a spatial filter for an access link; and transmit, to the repeater, the access link information over a backhaul link.

According to another aspect, there is provided an apparatus comprising means for: obtaining access link information of a repeater, wherein the access link information comprises received power of one or more reference signals, or an indication of a spatial filter for an access link; and transmitting, to the repeater, the access link information over a backhaul link.

According to another aspect, there is provided a method comprising: obtaining, by an access point, access link information of a repeater, wherein the access link information comprises received power of one or more reference signals, or an indication of a spatial filter for an access link; and transmitting, by the access point, to the repeater, the access link information over a backhaul link.

According to another aspect, there is provided a computer program comprising instructions for causing an apparatus to perform at least the following: obtaining access link information of a repeater, wherein the access link information comprises received power of one or more reference signals, or an indication of a spatial filter for an access link; and transmitting, to the repeater, the access link information over a backhaul link.

According to another aspect, there is provided a computer program product comprising program instructions which, when run on a computing apparatus, cause the computing apparatus to perform at least the following: obtaining access link information of a repeater, wherein the access link information comprises received power of one or more reference signals, or an indication of a spatial filter for an access link; and transmitting, to the repeater, the access link information over a backhaul link.

According to another aspect, there is provided a computer readable medium comprising program instructions for causing an apparatus to perform at least the following: obtaining access link information of a repeater, wherein the access link information comprises received power of one or more reference signals, or an indication of a spatial filter for an access link; and transmitting, to the repeater, the access link information over a backhaul link.

According to another aspect, there is provided a non-transitory computer readable medium comprising program instructions for causing an apparatus to perform at least the following: obtaining access link information of a repeater, wherein the access link information comprises received power of one or more reference signals, or an indication of a spatial filter for an access link; and transmitting, to the repeater, the access link information over a backhaul link. According to another aspect, there is provided a system comprising at least a repeater and an access point of a wireless communication network. The access point is configured to: obtain access link information of the repeater, wherein the access link information comprises received power of one or more reference signals, or an indication of a spatial filter for an access link; and transmit, to the repeater, the access link information over a backhaul link. The repeater is configured to: receive the access link information from the access point over the backhaul link; and obtain, based at least partly on the access link information, at least one spatial filter pair for the backhaul link and the access link.

According to another aspect, there is provided a system comprising at least a repeater and an access point of a wireless communication network. The access point comprises means for: obtaining access link information of the repeater, wherein the access link information comprises received power of one or more reference signals, or an indication of a spatial filter for an access link; and transmitting, to the repeater, the access link information over a backhaul link. The repeater comprises means for: receiving the access link information from the access point over the backhaul link; and obtaining, based at least partly on the access link information, at least one spatial filter pair for the backhaul link and the access link.

### BRIEF DESCRIPTION OF THE DRAWINGS

In the following, various exemplary embodiments will be described in greater detail with reference to the accompanying drawings, in which

FIG. 1 illustrates an exemplary embodiment of a cellular communication network;

FIG. 2 illustrates a high-level schematic of smart repeater architecture;

FIG. 3 illustrates a beam refinement procedure;

FIG. 4 illustrates an example of initial beam-pair establishment;

FIG. 5 illustrates an example of access point beam refinement;

FIG. 6 illustrates an example of smart repeater backhaul beam refinement;

FIG. 7 illustrates an example of smart repeater access beam selection;

FIG. 8 illustrates simultaneous beam refinement procedures over a single set of reference signals according to an exemplary embodiment;

FIGS. 9-10 illustrate signaling diagrams according to some exemplary embodiments;

FIGS. 11-12 illustrate flow charts according to some exemplary embodiments;

FIGS. 13-14 illustrate apparatuses according to some exemplary embodiments.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different exemplary embodiments will be described using, as an example of an access architecture to which the exemplary embodiments may be applied, a radio access architecture based on long term evolution advanced (LTE Advanced, LTE-A), new radio (NR, 5G), or beyond 5G, without restricting the exemplary embodiments to such an architecture.

However, it is obvious for a person skilled in the art that the exemplary embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

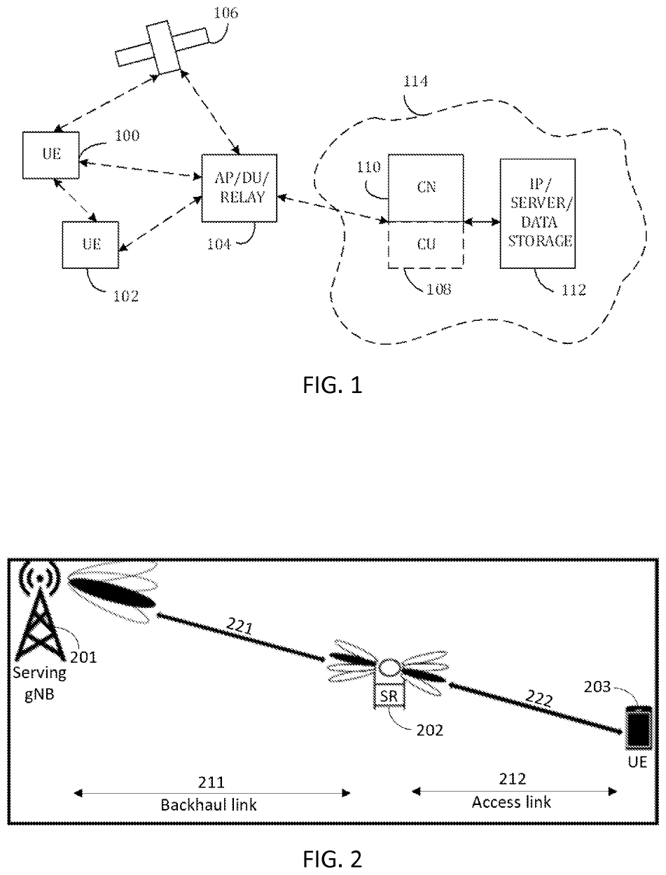

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The exemplary embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g)NodeB may be called uplink or reverse link and the physical link from the (e/g)NodeB to the user device may be called downlink or forward link. It should be appreciated that (e/g)NodeBs or their functionalities may be implemented by using any node, host, server or access point etc. entity suitable for such a usage.

A communication system may comprise more than one (e/g)NodeB, in which case the (e/g)NodeBs may also be configured to communicate with one another over links, wired or wireless, designed for the purpose. These links may be used for signaling purposes. The (e/g)NodeB may be a computing device configured to control the radio resources of communication system it is coupled to.

The (e/g)NodeB may also be referred to as a base station, an access point or any other type of interfacing device including a relay station capable of operating in a wireless environment. The (e/g)NodeB may include or be coupled to transceivers. From the transceivers of the (e/g)NodeB, a connection may be provided to an antenna unit that establishes bi-directional radio links to user devices.

The antenna unit may comprise a plurality of antennas or antenna elements. The (e/g)NodeB may further be connected to core network 110 (CN or next generation core NGC). Depending on the system, the counterpart on the CN side may be a serving gateway (S-GW, routing and forwarding user data packets), packet data network gateway (P-GW) for providing connectivity of user devices (UEs) to external packet data networks, mobility management entity (MME), access and mobility management function (AMF), or location management function (LMF), etc.

The user device (also called UE, user equipment, user terminal, terminal device, etc.) illustrates one type of an apparatus to which resources on the air interface may be allocated and assigned, and thus any feature described herein with a user device may be implemented with a corresponding apparatus, such as a relay node.

An example of such a relay node may be a layer 3 relay (self-backhauling relay) towards the base station. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and UE(s), and/or between the IAB node and other IAB nodes (multi-hop scenario).

An example of such a relay node may be a layer 1 relay called a repeater. The repeater may amplify the signal received from a base station or user device to the user device or base station.

The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. The user device may also be called user equipment (UE) or a terminal device.

It should be appreciated that a user device may also be a nearly exclusive uplink only device, of which an example may be a camera or video camera loading images or video clips to a network.

A user device may also be a device having capability to operate in Internet of Things (IoT) network which is a scenario in which objects may be provided with the ability to transfer data over a network without requiring human-to-human or human-to-computer interaction. The user device may also utilize cloud.

In some applications, a user device may comprise a small portable device with radio parts (such as a watch, earphones or eyeglasses) and the computation may be carried out in the cloud. The user device (or in some exemplary embodiments a layer 3 relay node) may be configured to perform one or more of user equipment functionalities. The user device may also be called a subscriber unit, mobile station, remote terminal, access terminal, user terminal, terminal device, or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

Radio network, e.g., fifth generation of cellular networks (5G), enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available.

Mobile communications, e.g., 5G system (5GS) may support a wide range of use cases and related applications including video streaming, augmented reality, different ways of data sharing and various forms of machine type applications (such as (massive) machine-type communications (mMTC), including vehicular safety, different sensors and real-time control.

5G may be expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave, below 6 GHz-cmWave-mmWave).

One of the concepts considered to be used in 5G networks may be network slicing in which multiple independent and dedicated virtual sub-networks (network instances) may be created within the substantially same infrastructure to run services that have different requirements on latency, reliability, throughput and mobility.

The architecture in LTE networks may be fully distributed in the radio and fully centralized in the core network. The low latency applications and services in 5G may need to bring the content close to the radio which leads to local break out and multi-access edge computing (MEC).

5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time.

Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or a base station comprising radio parts. It may also be possible that node operations will be distributed among a plurality of servers, nodes or hosts. Carrying out the RAN real-time functions at the RAN side (in a distributed unit, DU 104) and non-real time functions in a centralized manner (in a central unit, CU 108) may be enabled for example by application of cloud RAN architecture.

It should also be understood that the distribution of labour between core network operations and base station operations may differ from that of the LTE or even be non-existent. Some other technology advancements that may be used may be Big Data and all-IP, which may change the way networks are being constructed and managed. 5G (or new radio, NR) networks may be designed to support multiple hierarchies, where MEC servers may be placed between the core and the base station or nodeB (gNB). It should be appreciated that MEC may be applied in 4G networks as well.

5G may also utilize non-terrestrial communication, for example satellite communication, to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). At least one satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may also comprise other apparatuses, such as physical layer relay nodes or other network elements, etc. At least one of the (e/g)NodeBs or may be a Home(e/g)nodeB.

Furthermore, the (e/g)nodeB or base station may also be split into: a radio unit (RU) comprising a radio transceiver (TRX), i.e., a transmitter (Tx) and a receiver (Rx); one or more distributed units (DUs) that may be used for the so-called Layer 1 (L1) processing and real-time Layer 2 (L2) processing; and a central unit (CU) (also known as a centralized unit) that may be used for non-real-time L2 and Layer 3 (L3) processing. The CU may be connected to the one or more DUs for example by using an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU may be defined as a logical node hosting higher layer protocols, such as radio resource control (RRC), service data adaptation protocol (SDAP) and/or packet data convergence protocol (PDCP), of the (e/g)nodeB or base station. The DU may be defined as a logical node hosting radio link control (RLC), medium access control (MAC) and/or physical (PHY) layers of the (e/g)nodeB or base station.

The operation of the DU may be at least partly controlled by the CU. The CU may comprise a control plane (CU-CP), which may be defined as a logical node hosting the RRC and the control plane part of the PDCP protocol of the CU for the (e/g)nodeB or base station. The CU may further comprise a user plane (CU-UP), which may be defined as a logical node hosting the user plane part of the PDCP protocol and the SDAP protocol of the CU for the (e/g)nodeB or base station.

Cloud computing platforms may also be used to run the CU and/or DU. The CU may run in a cloud computing platform, which may be referred to as a virtualized CU (vCU). In addition to the vCU, there may also be a virtualized DU (vDU) running in a cloud computing platform.

Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of labour between the above-mentioned base station units, or different core network operations and base station operations, may differ.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. In multilayer networks, one access node may provide one kind of a cell or cells, and thus a plurality of (e/g)NodeBs may be needed to provide such a network structure.

For fulfilling the need for improving the deployment and performance of communication systems, the concept of “plug-and-play” (e/g)NodeBs may be introduced. A network which may be able to use “plug-and-play” (e/g)NodeBs, may include, in addition to Home (e/g)NodeBs (H(e/g)nodeBs), a home node B gateway, or HNB-GW (not shown in FIG. 1). A HNB Gateway (HNB-GW), which may be installed within an operator's network, may aggregate traffic from a large number of HNBs back to a core network.

Coverage is a fundamental aspect of cellular network deployments. However, establishing full-stack cells (i.e., dense deployment) may not always be possible (e.g., no availability of backhaul) or viable. To overcome such challenges, new types of network nodes have been considered to increase mobile operators' flexibility for their network deployments.

5G new radio (NR) Rel-16 provides one such option for flexible RAN extension, referred to as integrated access and backhaul (IAB). IAB is a multi-hop approach to network deployment and allows deployment of base stations with wireless backhaul transport. It works by having a fraction of the deployed base stations act as IAB donors, using a fiber/wired connection. The remainder of the base stations without a wired connection are called IAB nodes, which may be wirelessly connected to the IAB donor and/or another IAB node via a wireless backhaul link.

The IAB node is a relay node comprising a distributed unit (DU) component making it possible to appear as a regular cell to the UEs that it serves, and a mobile terminal (MT) component inheriting many properties of a regular UE, which connects to its parent node(s). Both the IAB node and the IAB donor may generate an equivalent cellular coverage area and appear identical to UEs in their coverage area. Thus, a benefit of IAB is that it enables flexible and dense deployment of NR cells without densifying the transport network proportionately. A diverse range of deployment scenarios can be envisioned for IAB, including support for outdoor small cell deployments, indoors, or even mobile relays (e.g., on buses or trains).

Another type of network node is the radio frequency (RF) repeater. RF repeaters have been used in 2G, 3G and 4G deployments to supplement the coverage provided by regular full-stack cells with various transmission power characteristics. The main advantages of RF repeaters are their ease of deployment and the fact that they do not increase latency. The main disadvantage is that they amplify signal and noise and, hence, may contribute to an increase of interference (pollution) in the system.

Within RF repeaters, there are different categories depending on the power characteristics and the amount of spectrum that they are configured to amplify (e.g., single band, multi-band, etc.). RF repeaters are non-regenerative type of relay nodes, which may amplify and forward everything that they receive. RF repeaters may be full-duplex nodes, which do not differentiate between uplink (UL) and downlink (DL) from transmission or reception standpoint.

As 5G NR moves to higher frequencies (around 6 GHz for frequency range one, FR1, deployments and above 24 GHz for frequency range two, FR2) propagation conditions degrade compared to lower frequencies, thus exacerbating the coverage challenges. As a result, further densification of cells may be necessary. Multi-antenna techniques consisting of massive MIMO for FR1 and analog beamforming for FR2 assist in coping with the more challenging propagation conditions of these higher frequencies. The frequency bands defined at this higher frequency regime may use time-division duplexing (TDD).

Another common property of NR systems is the use of multi-beam operation with associated beam management in FR2. Since RF repeaters may not be able to provide the beam management for NR devices, it is envisioned for NR to support a new class of relays, called the smart repeater (SR). Smart repeaters may support advanced beam management techniques and perform advanced time, frequency, and directional (uplink and/or downlink) resource amplification and forwarding.

FIG. 2 illustrates a high-level schematic of smart repeater (SR) architecture with a dedicated link for gNB-to-SR and the analogue pass-through signal from the gNB 201 to the UE 203. The smart repeater 202 selects one active backhaul beam for the backhaul link 211 between the gNB 201 and the smart repeater 202, and one active access beam for the access link 212 between the smart repeater 202 and the UE 203.

As illustrated in FIG. 2, the smart repeater benefits from a dedicated control channel 221 to communicate with the gNB. The control channel 221 can be deployed as the legacy 3GPP 5G NR gNB-UE interface or a new gNB-SR interface.

Furthermore, there may be a legacy 5G NR gNB-UE interface 222 between the smart repeater 202 and the UE 203. The user signal (data) may be received, amplified, and transmitted towards the UE 203 through the appropriate SR access beam without decoding or any digital modifications. Thus, the user signal may be transparent for the UE 203, such that the UE 203 assumes that it is connected directly to the gNB 201 and does not know that the data is coming through the smart repeater 202.

The smart repeater's capability of time/frequency pre-configured beamformed transmission significantly reduces the generated interference over the neighbouring nodes and decreases transmit energy spatial losses. Thus, it is advantageous compared to RF repeaters, which may amplify the received signal (including interference) with omni-directional antennas. Compared to IAB nodes, the smart repeater benefits from lower hardware and software complexity, as well as reduced latency.

Beam-based communication is one of the key enablers of 5G NR to enhance network capacity, throughput, and reliability. Transmission/reception through directional narrow beams generated by high-dimensional phased arrays increases the signal quality at desired UEs, reduces interference over neighbouring nodes, and compensates for additional propagation path-loss due to using higher carrier frequencies (e.g., FR2). Herein a beam may also be referred to as a spatial filter.

Beamforming may be defined as any technique that allows controlled focusing of the transmitted energy and/or received energy on a spatial support, when compared to the omni-directional baseline. Examples of spatial supports are directions/solid angles, spatial volumes, and other (at least partially) orthogonal fields in space. Controlled beamforming means that it is possible to focus energy on/from different spatial supports that may be partially overlapping.

A beam in the current application defines a spatial resource. A beam is also defined as a spatial filter. A beam is transmitted or received to/from a spatial direction, and a beam is formed by using a set of antennas, which is controlled by a controller (for example a baseband controller).

The shape and direction of a beam may be determined by what kind of function is used. This kind of special function may be called as a beamforming function or a mapping function or a spatial filter. When the UE or gNB applies the same spatial filter, it means that it forms the same beam, i.e., a radiation pattern of the antenna has the same direction, the same shape, and/or the same power of the beam.

A large number of antennas may be utilized by a base station and the UE in NR to obtain highly directional beamformed transmission and reception between the base station and the UE. Hybrid beamforming is a combination of analog beamforming that applies different phase shifters and/or amplitude weights on each antenna panel and digital beamforming that applies different digital precoders across panels. To fully capture beamforming gains, low-latency beam management techniques may be used for initial access, beam tracking, beam/radio link failure recovery, and during handover procedures. In NR, beam management is a set of Layer 1 (PHY) and/or Layer 2 (MAC) procedures, which mainly rely on measurements of reference signals, such as synchronization signal block (SSB) and channel state information reference signal (CSI-RS) in downlink, and sounding reference signal (SRS) in uplink.

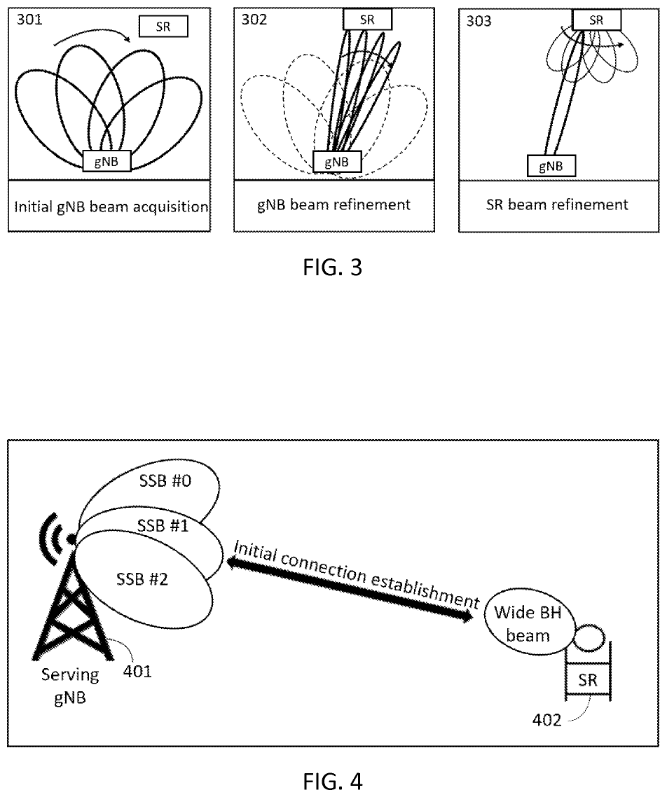

FIG. 3 illustrates a 5G NR beam refinement procedure for initial beam-pair establishment between the gNB and smart repeater. For a scenario where a UE is connected to a gNB through the SR amplification and forwarding (note that the SR is transparent to the UE), it is envisioned that 5G NR beam-pair selection between the gNB, SR, and UE includes the following phases: a first phase called gNB-SR-P1 for initial gNB beam acquisition (via SSB) as illustrated in block 301 of FIG. 3, a second phase called gNB-SR-P2 for gNB beam refinement (e.g., via CSI-RS) as illustrated in block 302 of FIG. 3, and a third phase called gNB-SR-P3 for SR beam refinement as illustrated in block 303 of FIG. 3.

FIG. 4 illustrates an example of the gNB-SR-P1 phase for beam-pair establishment between the serving gNB 401 and smart repeater 402. gNB-SR-P1 includes directional SSB beam transmission from the gNB 401 for initial connection establishment.

When the idle-mode smart repeater 402 or UE wants to establish a connection to the gNB 401, it acquires frame synchronization information and performs a random-access (RA) procedure. For this purpose, as presented in FIG. 4, the gNB broadcasts a set of wide SSB beams (a so-called SSB burst) in different directions, each carrying dedicated information such as: a primary synchronization signal (PSS), secondary synchronization signal (SSS), physical broadcast channel (PBCH), demodulation reference signal (DMRS), etc. For example, a given SSB burst may have a length of 5 ms and include up to 64 SSBs (in FR2). Depending on the network configuration, the SSB burst may have a periodicity between 5 to 160 ms.

In a first step, the smart repeater 402 establishes a connection with the gNB 401 to initialize the gNB-SR control channels. The SR may use the 5G NR Uu interface for this step. The smart repeater 402 measures the reference signal received power (RSRP) of the beams in the SSB burst through a static wide backhaul (BH) receive beam, selects the best SSB beam based on the measurements, decodes cell-specific information, and initiates initial connection establishment procedures towards the gNB 401.

After receiving SR-related configurations from the gNB 401, the smart repeater 402 amplifies and transmits (a set of) SSBs towards the UE using its wide access beam. The smart repeater 402 also relays for example the corresponding UL random-access channel (RACH) transmission opportunities from UE-to-gNB, so that the UE can trigger an initial access procedure and establish the initial connection with the gNB 401.

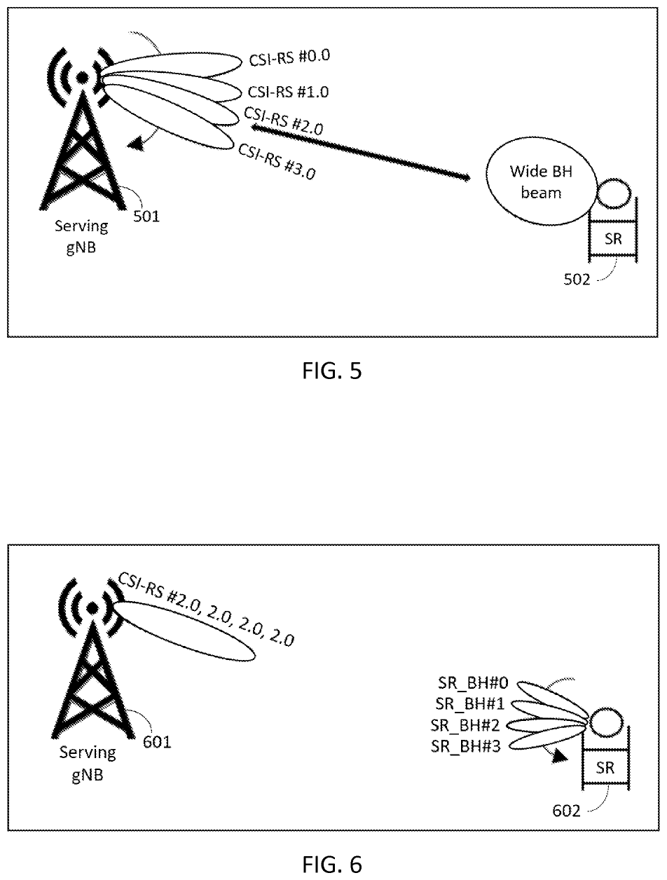

FIG. 5 illustrates an example of the gNB-SR-P2 phase, wherein the gNB 501 performs narrow CSI-RS beam transmission for backhaul beam-pair establishment between the gNB 501 and smart repeater 502.

After successful initial access connection (gNB-SR-P1), the gNB 501 may try to further boost the throughput of the backhaul link by communicating with the smart repeater 502 over a narrower beam. To this end, a set of finer (narrower) CSI-RS beams (e.g., CSI-RS #0.0, CSI-RS #1.0, CSI-RS #2.0 and CSI-RS #3.0 in FIG. 5) may be configured and transmitted within the spatial profile of the corresponding parent SSB beam. The smart repeater 502 measures the CSI-RS beams and reports one or more best CSI-RS beams to the gNB 501 based on the measurements.

For example, the smart repeater 502 may report CSI-RS beam #2.0 as the best CSI-RS beam. The gNB 501 may select the best CSI-RS beam (corresponding to the highest RSRP value) as the serving beam and provide the smart repeater 502 with beam failure recovery (BFR) configurations for the other beams.

FIG. 6 illustrates an example of the gNB-SR-P3 phase for SR backhaul receive beam refinement. The smart repeater 602 may align its backhaul narrow receive beam (SR_BH), while the gNB 601 maintains and repeats a fixed CSI-RS. For example, if CSI-RS beam #2.0 was the best CSI-RS beam reported by the smart repeater in the gNB-SR-P2 phase, the gNB 601 may transmit CSI-RS repetitions of CSI-RS #2.0, while the smart repeater 602 sweeps its backhaul receive beams (e.g., SR_BH #0, SR_BH #1, SR_BH #2, and SR_BH #3 in FIG. 6).

The smart repeater 602 may rely on the reference signals associated with non-zero-power channel state information reference signal (NZP-CSI-RS) resource set configured with the higher layer parameter “repetition” set to ‘ON’ with the same beam identifier (ID) from the gNB 601 in order to perform its narrow beam alignment procedure.

For example, the gNB 601 may indicate, to the smart repeater 602, the index of the CSI-RS resource set, whose transmission will be repeated, in an “nzp-CSI-RS-Resources” information element, and set the “repetition” information element to “on”. The repetition parameter indicates to the smart repeater 601 that the NZP-CSI-RS resource set are transmitted with the same downlink spatial filter. Furthermore, The “NZP-CSI-RS-ResourceId” information element may be used to identify a NZP-CSI-RS resource belonging to a certain NZP-CSI-RS resource set. The scheduling of such reference signals may be fully controlled by the gNB 601. At this stage, the smart repeater 602 may not report the measurements to the gNB 601.

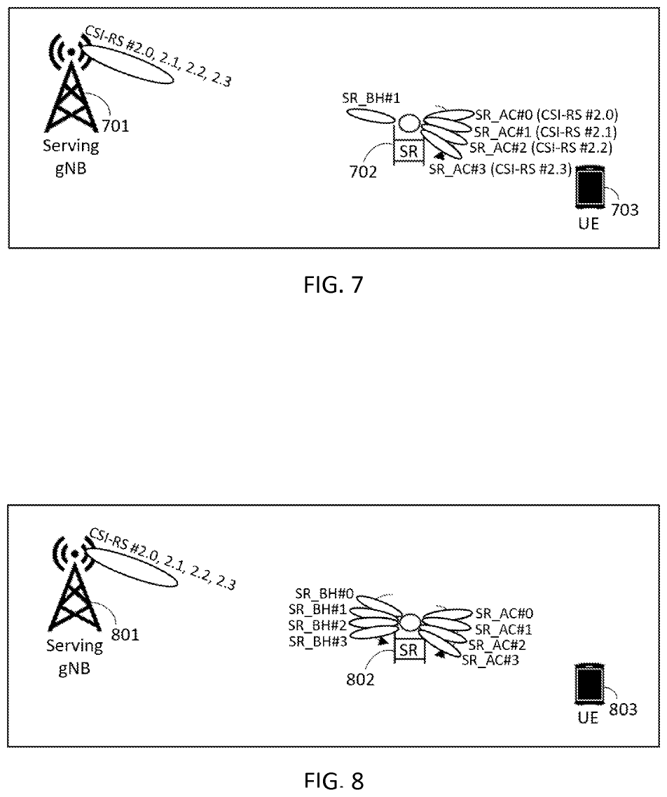

FIG. 7 illustrates an example of SR access beam selection. SR access beam management pointing to the UE 703 may be done via a phase called SR-UE-P2 where, as presented in FIG. 7. The gNB 701 sequentially transmits a burst of CSI-RS signals from gNB-to-SR sharing the same radiation pattern (e.g., spatial filter/support or angular direction) but with different beam IDs (e.g., CSI-RS #2.0, #2.1, #2.2, and #2.3 in FIG. 7).

The smart repeater 702 receives the CSI-RS signals with the same SR backhaul beam (e.g., SR_BH #1), and performs access beam sweeping by mapping each gNB CSI-RS signal to an SR access beam. The smart repeater 702 transmits the received CSI-RS towards the UE 703.

For example, the smart repeater 702 may map a first CSI-RS (CSI-RS #2.0) to a first SR access beam (SR_AC #0), a second CSI-RS (CSI-RS #2.1) to a second SR access beam (SR_AC #1), a third CSI-RS (CSI-RS #2.2) to a third SR access beam (SR_AC #2), and a fourth CSI-RS (CSI-RS #2.3) to a fourth SR access beam (SR_AC #3). In other words, the CSI-RS signals are repeated by the smart repeater 702 on the SR-to-UE access (SR_AC) link with different spatial filters (angular directions).

The UE 703 measures the SR access beams and reports one or more best CSI-RS beam ID(s) (and corresponding RSRP values) via the SR uplink path to the gNB 701. The gNB 701 then informs the SR 702 about the best UE-measured CSI-RS beam ID (e.g., CSI-RS #2.2).

It should be noted that there is no direct communication link between the smart repeater 702 and the UE 703. Based on the applied mapping between the CSI-RS beam IDs and the SR access beams, the smart repeater 702 determines the best SR access beam towards the UE (e.g., SR_AC #2).

To enhance the coverage, maximize the throughput, and reduce the interference, smart repeaters may be provided with multiple antennas and extensive beamforming capability at both backhaul and access sides exhibiting several beam configurations. For example, a smart repeater may exhibit 8 or more different beam configurations at each side that are exposed in the NR framework, or even more if base station hardware is used. For example, for FR2, there may be be 32 or 64 refined beams on the access side, and similar numbers on the backhaul side.

As discussed above, with current solutions, finding the optimum SR backhaul beam (gNB-SR-P3 phase) and SR access beam (SR-UE-P2 phase) may require the gNB to transmit two separate sets of CSI-RS. Such a high number of gNB CSI-RS transmissions is resource-consuming and a timely procedure, which may be an issue for example in loaded cell scenarios.

Moreover, for scenarios with mobile smart repeaters (e.g., a smart repeater installed on the roof of a bus, train or car, or cases with mobile-SR-to-mobile-SR communications), and/or due to UE mobility and rotation, the need for realignment of SR beams becomes more frequent, which significantly increases the required periodicity and resource usage of CSI-RS transmissions.

As a more visual example, one can imagine a train with a smart repeater on the roof, where the SR-UE refined beams need constant tracking/measuring, as the UEs are rotating and moving. At the same time, the gNB-SR refined beams need constant tracking/measuring, as the train moves. The same applies to UEs that are static, but are served by a mobile smart repeater, for example UEs outside of the train, or unmanned aerial vehicles (UAVs) or drones that serve as smart repeaters.

One solution to reduce the overhead is to simultaneously perform gNB-SR-P3 and SR-UE-P2 using one set of CSI-RS resources. The solution includes: the repeater receives access link information from an access point over a backhaul link, wherein the access link information comprises received power of one or more reference signals, or an indication of a spatial filter for an access link; and obtains, based at least partly on the access link information, at least one spatial filter pair for the backhaul link and the access link. The access point may be a gNB or any network node, which supports radio access functionality.

It should be noted that the CSI-RS in the current application is an example, and any other reference signal (RS) may alternatively be used for the purpose of beam refinement.

FIG. 8 illustrates simultaneous gNB-SR-P3 and SR-UE-P2 beam refinement procedures over the same set of CSI-RS resources according to an exemplary embodiment.

In FIG. 8, the gNB 801 transmits a set of CSI-RS signals with the same angular direction but with different CSI-RS beam IDs (e.g., CSI-RS #2.0, #2.1, #2.2, and #2.3). The smart repeater 802 creates a mapping between an individual SR backhaul beam and an SR access beam.

For example, the smart repeater 802 may map a first CSI-RS (CSI-RS #2.0) to a first backhaul beam (SR_BH #0) and a first access beam (SR_AC #0), a second CSI-RS (CSI-RS #2.1) to a second backhaul beam (SR_BH #1) and a second access beam (SR_AC #1), a third CSI-RS (CSI-RS #2.2) to a third backhaul beam (SR_BH #2) and a third access beam (SR_AC #2), and a fourth CSI-RS (CSI-RS #2.3) to a fourth backhaul beam (SR_BH #3) and a fourth access beam (SR_AC #3).

When there is a new CSI-RS transmission, the smart repeater 802 performs backhaul beam sweeping and measures the RSRP of the SR backhaul beams (e.g., SR_BH #0, #1, #2, and #3). At the same time, the smart repeater 802 amplifies the received signals with a fixed pre-determined level and transmits them over the corresponding SR access beams (e.g., SR_AC #0, #1, #2, and #3) according to the mapping, so that the UE 803 can measure the beams as well.

In the example of FIG. 8, for simplicity, the number of gNB CSI-RS transmissions are equal to the number of SR backhaul beams and SR access beams, and the number of SR backhaul beams equal that of the SR access beams. However, for a scenario with a different number of backhaul and access beams, the number of CSI-RS transmissions may be equal to the maximum number of access or backhaul beams, and the smart repeater can re-transmit over some of the beams.

However, one of the main challenges of applying the above solution of FIG. 8 is suboptimal access beam selection and reporting by the UE due to transmission of non-normalized access beams with different power levels. This happens, when the smart repeater amplifies the received signals with the same power amplification (PA) gain (e.g., 70 dB), and therefore the characteristics (e.g., RSRP) of the backhaul beams affect the transmission power of the access beams, and hence access beam sweep evaluation by the UE. Since the backhaul beam measurement and amplification are substantially simultaneous (e.g., with a few nanoseconds latency), the smart repeater may not be able to rapidly measure and apply individual amplification gain for each SR access beam to compensate different SR backhaul beam received RSRP offset values.

Table 1 below illustrates an example of UE misdetection of the best SR access beam applying the setup of FIG. 8, when the smart repeater 802 amplifies all CSI-RS signals with the same PA gain, where the backhaul beam qualities affect the UE-measured RSRP of the access beams. In other words, the received signal quality of the SR backhaul beams affect the transmission power of the SR access beams, and hence the UE-measured RSRP values.

As a result, in the example of Table 1, the UE reports CSI-RS #2.1 corresponding to SR_AC #1 as the best measured beam (with the highest UE-measured RSRP). However, in this example, SR_AC #2 is actually the best SR access beam (SR_AC #2 offers a −55 dB path gain, which is 5 dB higher than that of SR_AC #1 with −60 dB path gain), and SR_BH #1 is the best SR backhaul beam (highest SR_BH measured RSRP). In other words, in this example, SR_1BH #1 and SR_AC #2 are the optimum SR beam pair for the backhaul link and the access link.

TABLE 1
sub-optimal AC and BH link selection

| | | | | SR_AC path | |
|---|---|---|---|---|---|
| | | | | gain | |
| | SR_BH | | | (antenna/beam | RSRP |
| | measured | Power | SR_AC Tx | gain, pathloss, | measured |
| Beam pair | RSRP | amplification | power | fading, etc.) | by UE |
| mapping | [dBm] | gain [dB] | [dBm] | [dBm] | [dBm] |
| CSI-RS #2.0 | −80 | 70 | −10 | −90 | −100 |
| to SR_BH#0 | | | | | |
| to SR_AC#0 | | | | | |
| CSI-RS #2.1 | −60 | 70 | 10 | −60 | −50 |
| to SR_BH#1 | | | | | |
| to SR_AC#1 | | | | | |
| CSI-RS #2.2 | −70 | 70 | 0 | −55 | −55 |
| to SR_BH#2 | | | | | |
| to SR_AC#2 | | | | | |
| CSI-RS #2.3 | −75 | 70 | −5 | −80 | −85 |
| to SR_BH#3 | | | | | |
| to SR_AC#3 | | | | | |

Some exemplary embodiments enhance the SR beam refinement procedure by jointly performing the gNB-SR-P3 and SR-UE-P2 beam search phases over the same set of CSI-RS resources that are transmitted by the gNB. In other words, some exemplary embodiments enable to jointly determine the best backhaul beam for the smart repeater and the best access beam for a given UE by using the same CSI-RS resource set.

In some exemplary embodiments, the smart repeater may fine-tune its backhaul and access beams simultaneously by using one set of CSI-RS resources transmitted for SR-UE-P2, and thus avoid the need for dedicated transmission of CSI-RS repetitions for gNB-SR-P3. As such, the smart repeater may search for its best beams faster, which reduces the network resource consumption and reduces the beam search latency.

Some exemplary embodiments enable to have the information of both SR-measured RSRP of the backhaul beams and UE-measured RSRP of the access beams in one entity (the gNB or smart repeater) to compensate the impact of the backhaul beams on the UE-measured access beams, and to properly determine the optimum SR access beam for communication with the UE over the access link.

To achieve this goal, the smart repeater may amplify the incoming gNB backhaul signals by an equal amount, independently of the selected SR backhaul beam. At the same time, the smart repeater measures the power of the gNB CSI-RS transmitted on the same spatial support. Using this knowledge and the reports from the UE, either the gNB or the smart repeater may compensate the UE measurements to find the best CSI-RS beam ID and SR access beam to communicate towards the UE.

Table 2 below illustrates an example of obtaining the optimum SR access beam according to an exemplary embodiment. This example applies the setup of FIG. 8, wherein the gNB 801 or the smart repeater 802 may determine the CSI-RS ID of the proper SR access beam based on the measurement knowledge of the SR backhaul and access beams.

In this example, the UE 803 may not be able to reliably find the best SR access beam, as the channel between the gNB 801 and the smart repeater 802 is not constant, and thus the measurements are not directly comparable. Thus, the UE 803 reports a sub-optimal CSI-RS beam ID (CSI-RS #2.1 corresponding to SR_AC #1) to the network, because the non-normalized CSI-RS signals transmitted from the SR access beams have different transmission power levels caused by unbalanced signal quality received through the SR backhaul beams.

In this example, SR_AC #2 is the optimum normalized SR beam for the access link (SR_AC #2 offers a −55 dB path gain, which is 5 dB higher than that of SR_AC #1 with −60 dB path gain). Having the measurements of both the SR access and backhaul beams make it possible to compensate the UE measurement results and avoid the above issue, as the gNB or smart repeater can determine the actual normalized value of path gain (presented in the “Compensated UE-reported RSRP” column of Table 2) for each SR access beam by subtracting the delta-offset RSRP values of the SR backhaul beams (calculated compared to the lowest measured SR backhaul beam) from the UE-measured SR access beams. By doing this, as can be seen from Table 2, the highest value (CSI-RS #2.2 corresponding to SR_AC #2) in the “Compensated UE-reported RSRP” column represents the optimum normalized SR access beam.

TABLE 2
optimal AC and BH link selection

| | SR_BH | | Power | SR_AC | SR_AC | RSRP | Compensated |
|---|---|---|---|---|---|---|---|
| Beam | measured | Delta- | amplification | Tx | path | measured | UE-reported |
| pair | RSRP | offset | gain | power | gain | by UE | RSRP |
| mapping | [dBm] | [dB] | [dB] | [dBm] | [dBm] | [dBm] | [dBm] |
| CSI-RS | −80 | −80 − (−80 = 0 | 70 | −10 | −90 | −100 | −100 − 0 = −100 |
| #2.0 to | | | | | | | |
| SR_BH#0 | | | | | | | |
| to | | | | | | | |
| SR_AC#0 | | | | | | | |
| CSI-RS | −60 | −60 − (−80 = +20 | 70 | 10 | −60 | −50 | −50 − 20 = −70 |
| #2.1 to | | | | | | | |
| SR_BH#1 | | | | | | | |
| to | | | | | | | |
| SR_AC#1 | | | | | | | |
| CSI-RS | −70 | −70 − (−80 = +10 | 70 | 0 | −55 | −55 | −55 − 10 = −65 |
| #2.2 to | | | | | | | |
| SR_BH#2 | | | | | | | |
| to | | | | | | | |
| SR_AC#2 | | | | | | | |
| CSI-RS | −75 | −75 − (−80 = +5 | 70 | −5 | −80 | −85 | −85 −5 = −90 |
| #2.3 to | | | | | | | |
| SR_BH#3 | | | | | | | |
| to | | | | | | | |
| SR_AC#3 | | | | | | | |

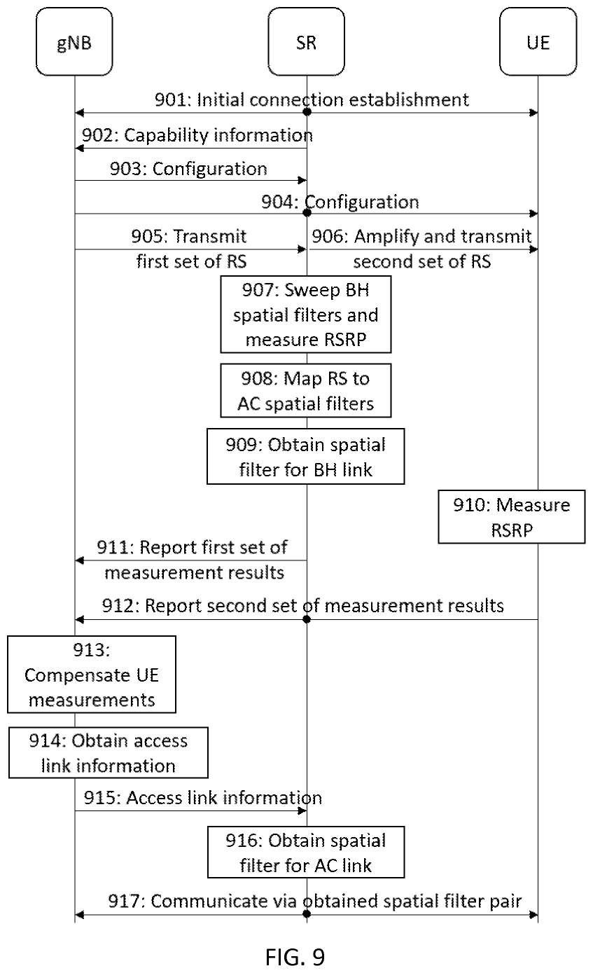

FIG. 9 illustrates a signaling diagram according to an exemplary embodiment, wherein the reference signal identifier (e.g., CSI-RS beam ID) corresponding to the best SR access beam (spatial filter) is obtained by the access point (e.g., gNB) based on RSRP measurements reported by both the smart repeater and the UE.

Referring to FIG. 9, in step 901, the smart repeater (SR) and at least one UE establish an initial connection to the access point (e.g., gNB) using wide SR spatial filters (beams). The smart repeater may also inform the access point about the number of backhaul and access beams of the smart repeater.

In step 902, the smart repeater may transmit capability information to the access point over a backhaul link between the smart repeater and the access point, wherein the capability information comprises a capability indication of performing joint backhaul and access spatial filter (beam) refinement procedures at the smart repeater. For example, the capability information may be transmitted in a medium access control (MAC) control element (CE) in the uplink, or radio resource control (RRC).

The capability information helps the access point to not schedule dedicated reference signal repetitions for gNB-SR-P3 specifically, but to wait until the at least one UE is available for SR/gNB-UE-P2. In case no UE is available or can be scheduled, in a reasonable time window (e.g., half of the L1/RSRP CSI-RS periodicity), then the access point may fall back to dedicated gNB-SR-P3.

In step 903, the access point may transmit a backhaul resource configuration to the smart repeater over the backhaul link, wherein the backhaul resource configuration indicates one or more time-frequency resources used for a first set of reference signals.

With the backhaul resource configuration, the access point configures the smart repeater for the access beam sweeping. For example, the access point may transmit the backhaul resource configuration to the smart repeater semi-statically or periodically to indicate the time-division duplexing (TDD) time slot and reference signal resource structure used for each active reference signal beam of the access point. With the backhaul resource configuration, the access point may also configure the smart repeater to report RSRP measurements for the SR backhaul spatial filters (backhaul beams).

In step 904, the access point may configure the at least one UE for reference signal beam measurement and reporting.

In step 905, the access point may transmit a first set of reference signals (RS) to the smart repeater with the same spatial filter (angular direction) but with different identifiers (e.g., beam IDs) to simulate sweeping. The repetition flag may not be set in the UE RS resource RRM configuration, despite the repetition-like behaviour exhibited by the access point. The first set of reference signals may comprise at least one of: channel state information reference signal (CSI-RS), primary synchronization signal (PSS), secondary synchronization signal (SSS), or tracking reference signal (TRS).

In step 906, the smart repeater may amplify and transmit a second set of reference signals to the at least one UE over the access link with different spatial filters, wherein the second set of reference signals correspond to the first set of reference signals. In other words, the smart repeater may amplify and forward the received first set of reference signals (i.e., the second set of reference signals may be the same as the first set of reference signals). The smart repeater may amplify each reference signal in the second set of reference signals with an equal amount (i.e., with the same amplification gain) upon transmitting the second set of reference signals over the access link.

In step 907, the smart repeater may sweep its backhaul (BH) spatial filters (backhaul beams) and measure the received power (e.g., RSRP) for each reference signal (resource) of the first set of reference signals on the backhaul spatial filters to obtain a first set of measurement results indicating received power of the first set of reference signals.

In step 908, the smart repeater may map the first set of reference signals to a set of spatial filters used for transmitting the second set of reference signals over the access link. In other words, the smart repeater may map each reference signal in the received first set of reference to a spatial filter (beam) of the access (AC) link.

In step 909, the smart repeater may obtain, or select, a spatial filter (beam) for the backhaul link based on the first set of measurement results obtained in step 907. For example, the smart repeater may select the spatial filter with the highest measured RSRP.

In step 910, the at least one UE may measure received power (e.g., RSRP) of the second set of reference signals received through the different spatial filters over the access link to obtain a second set of measurement results indicating received power of the second set of reference signals.

In step 911, the smart repeater may transmit a report to the access point over the backhaul link, wherein the report comprises the first set of measurement results indicating received power of the first set of reference signals.

In other words, the smart repeater reports the RS identifiers (e.g., index of each RS resource in the configured RS resource set) and corresponding measured power (e.g., L1/RSRP) values to the access point. In one example, the actual value of each measured RSRP may be reported. In another example, the offset values with respect to the highest or lowest measured spatial filter (beam) can be reported.

In step 912, the at least one UE may transmit a report to the access point to report the second set of measurement results obtained in step 910. In other words, the UE reports the measured spatial filters and the corresponding measured RSRP values (or the offset with respect to the best beam) to the access point through the uplink path amplified by the smart repeater.

In step 913, the access point may compensate the second set of measurement results based on the first set of measurement results. In other words, based on the first set of measurement results and the second set of measurement results, the access point compensates the impact of the backhaul spatial filter sweep (beam sweep) of step 907 on the measurements of the access link spatial filters (beams) performed by the UE in step 910.

For example, for each reference signal n received by the smart repeater through a backhaul link spatial filter i and transmitted though an access link spatial filter j, the access point may calculate the delta offset with respect to the lowest measured value in the first set of measurement results as:

$${Delta}_{n} = {SR\_BH}_{i}^{RSRP} - ( {min}_{k} {SR\_BH}_{k}^{RSRP} )$$

where SR_BHᵢ^{RSRP} is the measured RSRP of backhaul link spatial filter i, and SR_BHₖ^{RSRP} is the measured RSRP of access link spatial filter j.

The access point may compensate the RSRP values of the second set of measurement results with the calculated delta offset as follows:

$$Compensated {RS}_{n}^{RSRP} = {SR\_AC}_{j}^{RSRP} - {Delta}_{n}$$

In step 914, the access point obtains, or determines, access link information of the smart repeater based at least partly on the compensated second set of measurement results, wherein the access link information comprises an indication of a spatial filter for the access link.

The indication of the spatial filter for the access link may comprise one or more spatial filters used over the access link, or a pair of spatial filters between the backhaul link and the access link. The indication may comprise, for example, an identifier of a reference signal from the first set of reference signals, which would have provided the highest RSRP, if the second set of reference signals had been transmitted with normalized transmission power (from an SR perspective). For example, the identifier n*of the reference signal (corresponding to access link spatial filter j* according to the mapping from step 908) may be obtained as follows:

$${n}^{*} = {Arg max}_{n} ( Compensated {RS}_{n}^{RSRP} )$$

In step 915, the access point transmits the access link information to the smart repeater.

In step 916, based on the access link information and the applied mapping in step 908, the smart repeater obtains, or determines, a spatial filter (beam) for communicating with the at least one UE over the access link. Thus, the smart repeater obtains, based at least partly on the access link information, at least one spatial filter pair (beam pair) for the backhaul link and the access link.

In step 917, the smart repeater may communicate with the at least one UE and the access point via the obtained at least one spatial filter pair. For example, the smart repeater may receive one or more signals from the access point via the spatial filter obtained for the backhaul link in step 909, and amplify and transmit the one or more signals to the at least one UE via the spatial filter obtained for the access link in step 916.

Alternatively or additionally, the smart repeater may receive one or more signals from the at least one UE via the spatial filter obtained for the access link in step 916, and amplify and transmit the one or more signals to the access point via the spatial filter obtained for the backhaul link in step 909.

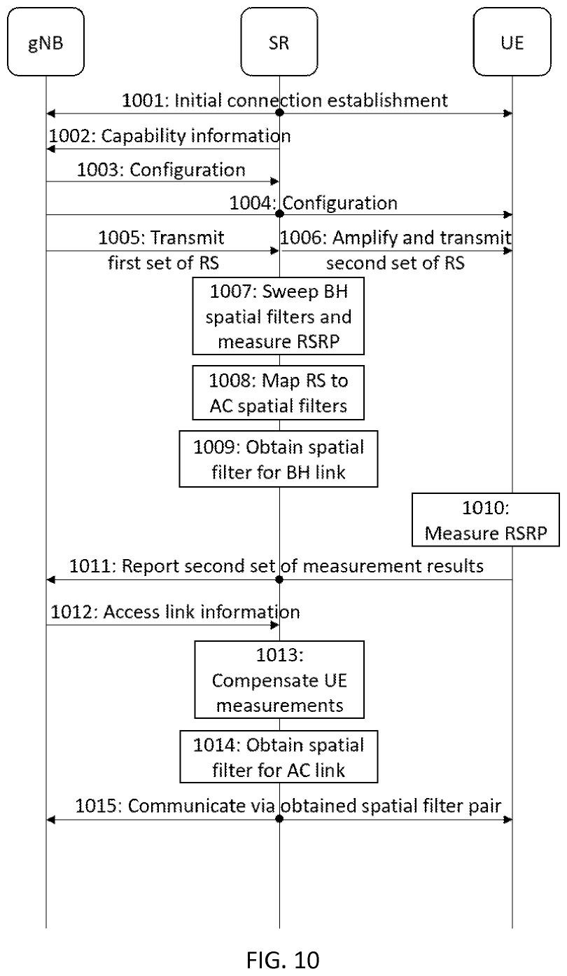

FIG. 10 illustrates a signaling diagram according to another exemplary embodiment, where the best access beam is obtained by the smart repeater. In this exemplary embodiment, the access point provides the UE measurements to the smart repeater. Based on this information and the smart repeater's own RSRP measurements of the SR backhaul beams, the smart repeater determines the optimum access beam for transmission toward that specific UE.

Referring to FIG. 10, in step 1001, the smart repeater (SR) and at least one UE may establish an initial connection to the access point (e.g., gNB) using wide SR spatial filters (beams). The smart repeater may also inform the access point about the number of backhaul and access beams of the smart repeater.

In step 1002, the smart repeater may transmit capability information to the access point over a backhaul link between the smart repeater and the access point, wherein the capability information comprises a capability indication of performing joint backhaul and access spatial filter (beam) refinement procedures at the smart repeater. For example, the capability information may be transmitted in a medium access control (MAC) control element (CE) in the uplink or RRC.

The capability information helps the access point to not schedule dedicated reference signal repetitions for gNB-SR-P3 specifically, but to wait until the at least one UE is available for SR/gNB-UE-P2. In case no UE is available or can be scheduled, in a reasonable time window (e.g., half of the L1/RSRP CSI-RS periodicity), then the access point may fall back to dedicated gNB-SR-P3.

In step 1003, the access point may transmit a backhaul resource configuration to the smart repeater over the backhaul link, wherein the backhaul resource configuration indicates one or more time-frequency resources used for a first set of reference signals. With the backhaul resource configuration, the access point configures the smart repeater for the access beam sweeping.

For example, the access point may transmit the backhaul resource configuration to the smart repeater semi-statically or periodically to indicate the time-division duplexing (TDD) time slot and reference signal resource structure used for each active reference signal beam of the access point.

In step 1004, the access point may configure the at least one UE for reference signal beam measurement and reporting.

In step 1005, the access point may transmit a first set of reference signals (RS) to the smart repeater with the same spatial filter (angular direction) but with different identifiers (e.g., beam IDs) to simulate sweeping. The repetition flag may not be set in the UE RS resource RRM configuration, despite the repetition-like behaviour exhibited by the access point.

The first set of reference signals may comprise at least one of: channel state information reference signal (CSI-RS), primary synchronization signal (PSS), secondary synchronization signal (SSS), or tracking reference signal (TRS).

In step 1006, the smart repeater may amplify and transmit a second set of reference signals to the at least one UE over the access link with different spatial filters, wherein the second set of reference signals correspond to the first set of reference signals. In other words, the smart repeater may amplify and forward the received first set of reference signals (i.e., the second set of reference signals may be the same as the first set of reference signals). The smart repeater may amplify each reference signal in the second set of reference signals with an equal amount (i.e., with the same amplification gain) upon transmitting the second set of reference signals over the access link.

In step 1007, the smart repeater may sweep its backhaul (BH) spatial filters (backhaul beams) and measure the received power (e.g., RSRP) for each reference signal (resource) of the first set of reference signals on the backhaul spatial filters to obtain a first set of measurement results indicating received power of the first set of reference signals.

In step 1008, the smart repeater may map the first set of reference signals to a set of spatial filters used for transmitting the second set of reference signals over the access link. In other words, the smart repeater may map each reference signal in the received first set of reference to a spatial filter (beam) of the access (AC) link.

In step 1009, the smart repeater may obtain, or select, a spatial filter (beam) for the backhaul link based on the first set of measurement results obtained in step 1007. For example, the smart repeater may select the spatial filter with the highest measured RSRP.

In step 1010, the at least one UE may measure received power (e.g., RSRP) of the second set of reference signals received through the different spatial filters over the access link to obtain a second set of measurement results indicating received power of the second set of reference signals.

In step 1011, the at least one UE may transmit a report to the access point to report the second set of measurement results obtained in step 1010. In other words, the UE may report the measured spatial filters and the corresponding measured RSRP values (or the offset with respect to the best beam) to the access point through the uplink path amplified by the smart repeater.

In step 1012, the access point transmits access link information to the smart repeater, wherein the access link information comprises the second set of measurement results indicating received power of the second set of reference signals. This indirect reporting is needed, since the UE and smart repeater do not have a direct communication link.

In step 1013, the smart repeater may compensate the second set of measurement results obtained from the access link information based on the first set of measurement results. In other words, based on first set of measurement results, the second set of measurement results and the applied mapping in step 1008, the smart repeater compensates the impact of the backhaul spatial filter on the spatial filters of the access link.

For example, for each reference signal n received by the smart repeater through a backhaul link spatial filter i and transmitted though an access link spatial filter j, the access point may calculate the delta offset with respect to the lowest measured value in the first set of measurement results as:

$${Delta}_{n} = {SR\_BH}_{i}^{RSRP} - ( {min}_{k} {SR\_BH}_{k}^{RSRP} )$$

where SR_BHᵢ^{RSRP} is the measured RSRP of backhaul link spatial filter i, and SR_BHₖ^{RSRP} is the measured RSRP of access link spatial filter j.

The smart repeater may compensate the RSRP values of the second set of measurement results with the calculated delta offset as follows:

$$Compensated {RS}_{n}^{RSRP} = {SR\_AC}_{j}^{RSRP} - {Delta}_{n}$$

In step 1014, based at least partly on the compensated second set of measurement results and the applied mapping in step 1008, the smart repeater obtains, or determines, a spatial filter (beam) for communicating with the at least one UE over the access link.

Thus, the smart repeater obtains, based at least partly on the access link information and the first set of measurement results of the first set of reference signals, at least one spatial filter pair (beam pair) for the backhaul link and the access link.

The obtained spatial filter for the access link may be the spatial filter, which would have provided the highest RSRP, if the second set of reference signals had been transmitted with normalized transmission power (from an SR perspective). For example, the spatial filter j* may be obtained by determining the identifier n*of the reference signal (corresponding to the access link spatial filter j* according to the mapping from step 1008) as follows:

$${n}^{*} = {Arg max}_{n} ( Compensated {RS}_{n}^{RSRP} )$$

In step 1015, the smart repeater may communicate with the at least one UE and the access point via the obtained at least one spatial filter pair.

It should be noted that some exemplary embodiments may also be applied for multiple UEs. In this case, the entity (access point or smart repeater) determining the SR spatial filter for the access link may repeat the calculations/compensation for each UE, but the measurements of the backhaul spatial filters may not change for each UE.

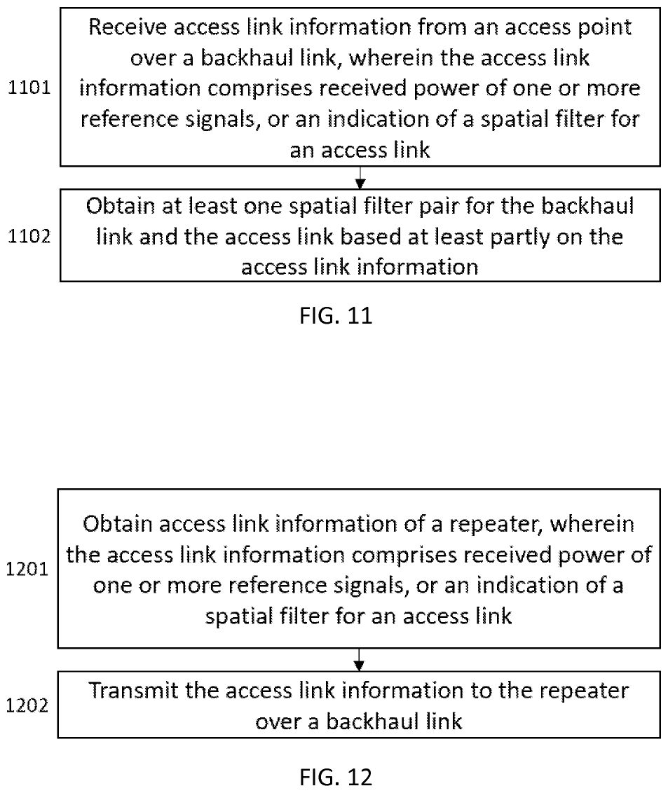

FIG. 11 illustrates a flow chart according to one or more exemplary embodiments. The steps illustrated in FIG. 11 may be performed by an apparatus such as, or comprised in, a (smart) repeater.

Referring to FIG. 11, in step 1101, access link information is received from an access point over a backhaul link, wherein the access link information comprises, or indicates, received power of one or more reference signals, or an indication of a spatial filter for an access link between the (smart) repeater and at least one UE. The at least one UE may also be referred to as a user equipment, user device, or terminal device herein.

In step 1102, at least one spatial filter pair for the backhaul link and the access link is obtained based at least partly on the access link information.

FIG. 12 illustrates a flow chart according to an exemplary embodiment. The steps illustrated in FIG. 12 may be performed by an apparatus such as, or comprised in, an access point (e.g., a gNB).

Referring to FIG. 12, in step 1201, access link information of a (smart) repeater is obtained, wherein the access link information comprises, or indicates, received power of one or more reference signals, or an indication of a spatial filter for an access link between the (smart repeater) and at least one UE. The at least one UE may also be referred to as a user equipment, user device, or terminal device herein.

In step 1202, the access link information is transmitted to the (smart) repeater over a backhaul link.

The steps and/or blocks described above by means of FIGS. 9-12 are in no absolute chronological order, and some of them may be performed simultaneously or in an order differing from the described one. Other steps and/or blocks may also be executed between them or within them. For example, steps 905-910 of FIG. 9 may be performed in lockstep (i.e., substantially simultaneously).

A technical advantage provided by some exemplary embodiments is that they reduce the number of RS transmissions by simultaneously performing the gNB-SR-P3 and SR-UE-P2 beam refinement procedures without power normalization and by avoiding sub-optimal selection of SR access beams (spatial filters for the access link). In other words, some exemplary embodiments enable joint SR backhaul and access beam refinement over one set of reference signals with no power normalization at the smart repeater by compensating for different SR access beam RSRP values caused by unbalanced RSRP of SR backhaul beams.

Some exemplary embodiments may save resources by reducing the need for two sets of RS beams to one set. In addition, some exemplary embodiments may reduce the SR complexity, since no power normalization is required at the SR. Some exemplary embodiments may also improve the SR performance by enabling it to tune its backhaul and access beams more frequently and with lower latency.

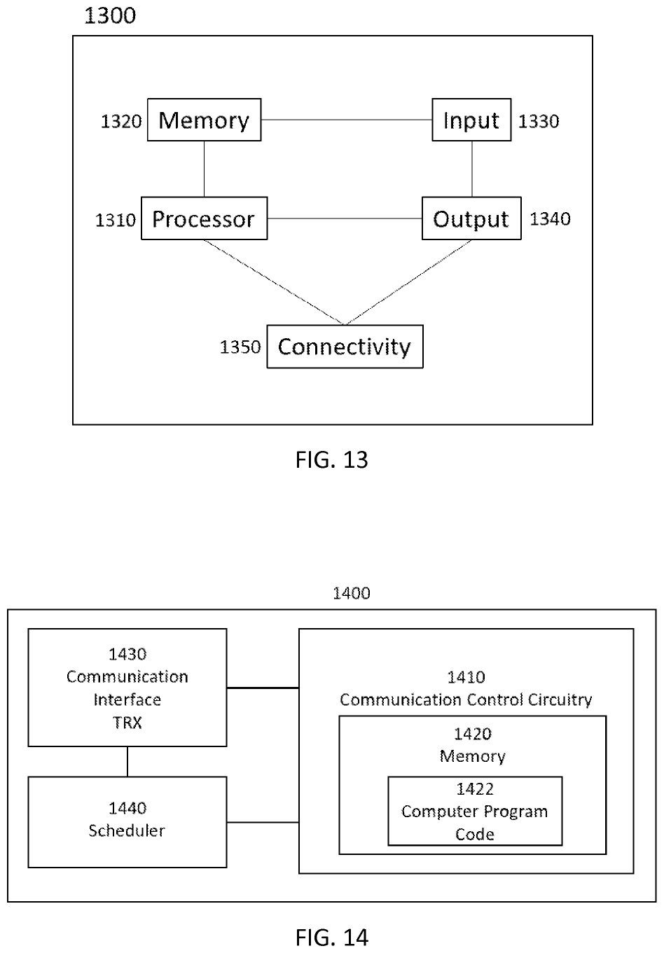

FIG. 13 illustrates an apparatus 1300, which may be an apparatus such as, or comprised in, a terminal device, according to an exemplary embodiment. The terminal device may also be referred to as a UE or user equipment herein. The apparatus 1300 comprises a processor 1310. The processor 1310 interprets computer program instructions and processes data. The processor 1310 may comprise one or more programmable processors. The processor 1310 may comprise programmable hardware with embedded firmware and may, alternatively or additionally, comprise one or more application-specific integrated circuits (ASICs).

The processor 1310 is coupled to a memory 1320. The processor is configured to read and write data to and from the memory 1320. The memory 1320 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 1320 stores computer readable instructions that are executed by the processor 1310. For example, non-volatile memory stores the computer readable instructions and the processor 1310 executes the instructions using volatile memory for temporary storage of data and/or instructions.

The computer readable instructions may have been pre-stored to the memory 1320 or, alternatively or additionally, they may be received, by the apparatus, via an electromagnetic carrier signal and/or may be copied from a physical entity such as a computer program product. Execution of the computer readable instructions causes the apparatus 1300 to perform one or more of the functionalities described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer.

The apparatus 1300 may further comprise, or be connected to, an input unit 1330. The input unit 1330 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 1330 may comprise an interface to which external devices may connect to.

The apparatus 1300 may also comprise an output unit 1340. The output unit may comprise or be connected to one or more displays capable of rendering visual content, such as a light emitting diode (LED) display, a liquid crystal display (LCD) and/or a liquid crystal on silicon (LCoS) display. The output unit 1340 may further comprise one or more audio outputs. The one or more audio outputs may be for example loudspeakers.

The apparatus 1300 further comprises a connectivity unit 1350. The connectivity unit 1350 enables wireless connectivity to one or more external devices. The connectivity unit 1350 comprises at least one transmitter and at least one receiver that may be integrated to the apparatus 1300 or that the apparatus 1300 may be connected to. The at least one transmitter comprises at least one transmission antenna, and the at least one receiver comprises at least one receiving antenna. The connectivity unit 1350 may comprise an integrated circuit or a set of integrated circuits that provide the wireless communication capability for the apparatus 1300. Alternatively, the wireless connectivity may be a hardwired application-specific integrated circuit (ASIC). The connectivity unit 1350 may comprise one or more components such as a power amplifier, digital front end (DFE), analog-to-digital converter (ADC), digital-to-analog converter (DAC), frequency converter, (de)modulator, and/or encoder/decoder circuitries, controlled by the corresponding controlling units.

It is to be noted that the apparatus 1300 may further comprise various components not illustrated in FIG. 13. The various components may be hardware components and/or software components.

The apparatus 1400 of FIG. 14 illustrates an exemplary embodiment of an apparatus such as, or comprised in, a network element of a wireless communication network. The network element may also be referred to, for example, as a repeater, a smart repeater, a network node, a RAN node, an integrated access and backhaul (IAB) node, an IAB donor node, a NodeB, an LTE evolved NodeB (eNB), a gNB, a base station, an NR base station, a 5G base station, an access node, an access point (AP), a distributed unit (DU), a central unit (CU), a baseband unit (BBU), a radio unit (RU), a radio head, a remote radio head (RRH), or a transmission and reception point (TRP). The apparatus 1400 may comprise, for example, a circuitry or a chipset applicable for realizing some of the described exemplary embodiments. The apparatus 1400 may be an electronic device comprising one or more electronic circuitries. The apparatus 1400 may comprise a communication control circuitry 1410 such as at least one processor, and at least one memory 1420 including a computer program code (software) 1422 wherein the at least one memory and the computer program code (software) 1422 are configured, with the at least one processor, to cause the apparatus 1400 to carry out some of the exemplary embodiments described above.

The processor is coupled to the memory 1420. The processor is configured to read and write data to and from the memory 1420. The memory 1420 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 1420 stores computer readable instructions that are executed by the processor. For example, non-volatile memory stores the computer readable instructions and the processor executes the instructions using volatile memory for temporary storage of data and/or instructions.

The computer readable instructions may have been pre-stored to the memory 1420 or, alternatively or additionally, they may be received, by the apparatus, via an electromagnetic carrier signal and/or may be copied from a physical entity such as a computer program product. Execution of the computer readable instructions causes the apparatus 1400 to perform one or more of the functionalities described above.

The memory 1420 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data. For example, the configuration database may store a current neighbour cell list, and, in some exemplary embodiments, structures of the frames used in the detected neighbour cells.

The apparatus 1400 may further comprise a communication interface 1430 comprising hardware and/or software for realizing communication connectivity according to one or more communication protocols. The communication interface 1430 comprises at least one transceiver (TRX) that may be integrated to the apparatus 1400 or that the apparatus 1400 may be connected to. The communication interface 1430 provides the apparatus with radio communication capabilities to communicate in the cellular communication system. The communication interface may, for example, provide a radio interface to terminal devices. The apparatus 1400 may further comprise another interface towards a core network such as the network coordinator apparatus and/or to the access nodes of the cellular communication system. The apparatus 1400 may further comprise a scheduler 1440 that is configured to allocate resources. The scheduler 1440 may be configured along with the communication control circuitry 1410 or it may be separately configured.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s)), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of exemplary embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the exemplary embodiments described above, but may vary within the scope of the claims. Therefore, all words and expressions should be interpreted broadly, and they are intended to illustrate, not to restrict, the exemplary embodiments.

1.-23. (canceled)

24. An apparatus comprising at least one processor, and at least one transceiver, wherein the at least one transceiver is configured to:
receive access link information from an access point over a backhaul link, wherein the access link information comprises received power of one or more reference signals, or an indication of a spatial filter for an access link; and
the at least one processor is configured to:
obtain, based at least partly on the access link information, at least one spatial filter pair for the backhaul link and the access link.

25. The apparatus according to claim 24, wherein the at least one transceiver is further configured to:
receive a first set of reference signals from the access point over the backhaul link with a same spatial filter; and
transmit a second set of reference signals to at least one terminal device over the access link with different spatial filters, wherein the second set of reference signals correspond to the first set of reference signals.

26. The apparatus according to claim 25, wherein the access link information comprises received power of the second set of reference signals, or the indication of the spatial filter for the access link; and
wherein the at least one spatial filter pair is obtained based at least partly on the access link information and the first set of reference signals.

27. The apparatus according to claim 24, wherein the at least one transceiver is further configured to:
amplify the second set of reference signals with an equal amount upon transmitting the second set of reference signals over the access link.

28. The apparatus according to claim 24, wherein the second set of reference signals corresponding to the first set of reference signals comprises:
mapping the first set of reference signals to a set of spatial filters used for transmitting the second set of reference signals over the access link, and
wherein the at least one spatial filter pair is obtained based at least partly on the mapping.

29. The apparatus according to claim 24, wherein the at least one processor is further configured to:
obtain a first set of measurement results indicating received power of the first set of reference signals;
obtain, from the access link information, a second set of measurement results indicating received power of the second set of reference signals; and
compensate the second set of measurement results based on the first set of measurement results,
wherein the at least one spatial filter pair is obtained based at least partly on the compensated second set of measurement results.

30. The apparatus according to claim 25, wherein the at least one transceiver is further configured to:
transmit a report to the access point over the backhaul link, wherein the report indicates received power of the first set of reference signals.

31. The apparatus according to claim 25, wherein the at least one transceiver is further configured to:
receive, over the backhaul link, a backhaul resource configuration, wherein the backhaul resource configuration indicates one or more time-frequency resources used for the first set of reference signals.

32. The apparatus according to claim 24, wherein the at least one transceiver is further configured to:
transmit, to the access point, over the backhaul link, capability information, wherein the capability information comprises a capability indication of joint backhaul and access spatial filter refinement.

33. The apparatus according to claim 24, wherein the at least one transceiver is further configured to:
communicate with the at least one terminal device via the obtained at least one spatial filter pair.

34. The apparatus according to claim 24, wherein the indication of the spatial filter for the access link comprises one or more spatial filters used over the access link, or a pair of spatial filters between the backhaul link and the access link.

35. The apparatus according to claim 24, wherein the one or more reference signals comprise at least one of: channel state information reference signal, CSI-RS, primary synchronization signal, secondary synchronization signal, or tracking reference signal, TRS.

36. An apparatus comprising at least one processor, and at least one transceiver, wherein the at least one processor is configured to:
obtain access link information of a repeater, wherein the access link information comprises received power of one or more reference signals, or an indication of a spatial filter for an access link; and
wherein the at least one transceiver is configured to:
transmit, to the repeater, the access link information over a backhaul link.

37. The apparatus according to claim 36, wherein the at least one transceiver is further configured to:
transmit a first set of reference signals to the repeater over the backhaul link, wherein the first set of reference signals are transmitted with a same spatial filter;
receive a first set of measurement results indicating received power of the first set of reference signals transmitted over the backhaul link; and
receive a second set of measurement results indicating received power of a second set of reference signals relayed by the repeater over the access link, wherein the second set of reference signals correspond to the first set of reference signals.

38. The apparatus according to claim 37, wherein the access link information is obtained based at least partly on the first set of measurement results and the second set of measurement results.

39. The apparatus according to claim 37, wherein the at least one processor is further configured to:
compensate the second set of measurement results based on the first set of measurement results.

40. The apparatus according to claim 36, wherein the at least one transceiver is further configured to:
transmit, to the repeater, over the backhaul link, a backhaul resource configuration, wherein the backhaul resource configuration indicates one or more time-frequency resources used for the first set of reference signals.

41. The apparatus according to claim 36, wherein the at least one transceiver is further configured to:
receive, from the repeater, over the backhaul link, capability information, wherein the capability information comprises a capability indication of joint backhaul and access spatial filter refinement.

42. The apparatus according to claim 36, wherein the one or more reference signals comprise at least one of: channel state information reference signal, CSI-RS, primary synchronization signal, secondary synchronization signal, or tracking reference signal, TRS.

43. A method comprising:
receiving, by a repeater, access link information from an access point over a backhaul link, wherein the access link information comprises received power of one or more reference signals, or an indication of a spatial filter for an access link; and
obtaining, by the repeater, based at least partly on the access link information, at least one spatial filter pair for the backhaul link and the access link.
